(19) United States
(12) Patent Application Publication
(10) Pub. No.: US 2019/0205387 A1
(43) Pub. Date: Jul. 4, 2019

(54) SENTENCE SCORING DEVICE AND PROGRAM

(71) Applicant: KONICA MINOLTA, INC., Tokyo (JP)

(72) Inventor: Kouichi TOMITA, Kawanishi-shi (JP)

(73) Assignee: KONICA MINOLTA, INC., Tokyo (JP)

(21) Appl. No.: 16/212,921

(22) Filed: Dec. 7, 2018

(30) Foreign Application Priority Data
Dec. 28, 2017 (JP) 2017-253028

(51) Int. Cl. G06F 17/27

(52) U.S. Cl. CPC G06F 17/2785; G06F 17/277

(57) ABSTRACT

A sentence scoring device includes a hardware processor that: extracts a sentence from a document; identifies a matter shown by the sentence; acquires a continuing period of the identified matter; derives a first weighting value of the sentence based on the acquired continuing period; extracts a keyword included in the sentence; derives a second weighting value of the sentence based on the extracted keyword; and determines a weighting value of the sentence based on the first weighting value and the second weighting value.

The entire disclosure of Japanese patent Application No. 2017-253028, filed on Dec. 28, 2017, is incorporated herein by reference in its entirety.

### BACKGROUND

### Technological Field

The present invention relates to a sentence scoring device and program capable of weighting a document.

### Description of the Related art

There is a method of text mining as a method of extracting useful information from text (sentences). According to this method, for example, a word and the like having a negative meaning, such as “defect”, can be extracted from text and put together. By reading the extracted part, only useful information in a document can be checked easily without reading the whole document.

As to how to determine a sentence to be extracted in a document, there is, for example, a prior art of a method that divides a sentence into words, and weights the entire sentence by using a degree of importance (weighting value) of each of the words.

JP 2009-128967 A discloses a method of determining a noun and a predicate in a document, and weighting each noun based on an expressed content of a predicate with respect to the noun. In this method, when a predicate with respect to a specific noun is a predicate of a concept expressing a state change, a first weighting value is set to the noun. When the predicate expresses a concept of existence or non-existence and is affirmative, a second weighting value is set to the noun. When the predicate expresses a concept of existence or non-existence and is negative, a third weighting value is set to the noun.

For example, FIG. 16 shows an example where weighting is performed by a method described in JP 2009-128967 A. When there are sentences, such as “the tumor has not expanded” and “no tumor is found”, “the tumor has not expanded” negates a state change, and “no tumor is found” negates existence. Although these sentences are both negative, a different weight is applied to the negation of a state change, which implies existence of a subject.

When a sentence is weighted, there is a case where factors other than a content of the sentence are preferably considered.

FIG. 17 shows a state Where weighting is performed for a document A and a document B. Both the documents A and B show that a problem has occurred. A degree of importance set to the problem shown in the document A, for which six weeks have elapsed since the problem occurs, is preferably higher than that set to the problem of the document B, which has just occurred, so that the problem shown in the document A is settled early.

However, the method described in JP 2009-128967 A and conventional methods perform weighting by setting the same degree of importance to the documents A and B, since such methods perform weighting based only on a content of a document, and do not support weighting in consideration of other external factors, such as a situation of a matter described in a document.

### SUMMARY

To solve the above problem, an object of the present invention is to provide a sentence scoring device and a program thereof that can perform weighting in consideration of a situation of a matter shown by a sentence.

To achieve the abovementioned object, according to an aspect of the present invention, a sentence scoring device reflecting one aspect of the present invention comprises a hardware processor that: extracts a sentence from a document; identifies a matter shown by the sentence; acquires a continuing period of the identified matter; derives a first weighting value of the sentence based on the acquired continuing period; extracts a keyword included in the sentence; derives a second weighting value of the sentence based on the extracted keyword; and determines a weighting value of the sentence based on the first weighting value and the second weighting value.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention;

FIG. 1 is a diagram showing an example of a document composition analysis system according to an embodiment of the present invention;

FIG. 2 is a block diagram showing a schematic configuration of a server as a sentence scoring device according to the present invention;

FIG. 3 is a diagram showing a state in which a sentence is extracted from a document;

FIG. 4 is a diagram showing a state in which a keyword and a title are extracted from a sentence, and weighting values of them;

FIG. 5 is a diagram showing a state which scoring of a sentence is performed based on a keyword and a title;

FIG. 6 is a diagram showing an example of measures taken when a plurality of titles of the same kind exist on the same layer;

FIG. 7 is a diagram showing a method of detecting a title used for scoring when the scoring is performed in consideration of only a title of one kind;

FIG. 8 is a diagram showing a state in which a matter shown by a sentence is registered in a scoring history;

FIG. 9 is a diagram showing an example where a final score is calculated based on a weighting value corresponding to a continuing period;

FIG. 10 is a diagram showing a state in Which a completed matter is set to a scoring history;

FIG. 11 is a diagram showing an example of a scoring history in which a “completed matter” is registered;

FIG. 12 is a diagram showing a coefficient relating to the number of times of recurrence of a matter;

FIG. 13 is a flowchart showing a process of performing scoring based on a keyword and a title;

FIG. 14 is a flowchart showing a process of performing final scoring based on a continuing period of a matter;

FIG. 15 is a flowchart showing a processing of scoring relating to recurrence;

FIG. 16 is a diagram showing an example of a problem that occurs when weighting is performed based only on a content of text; and

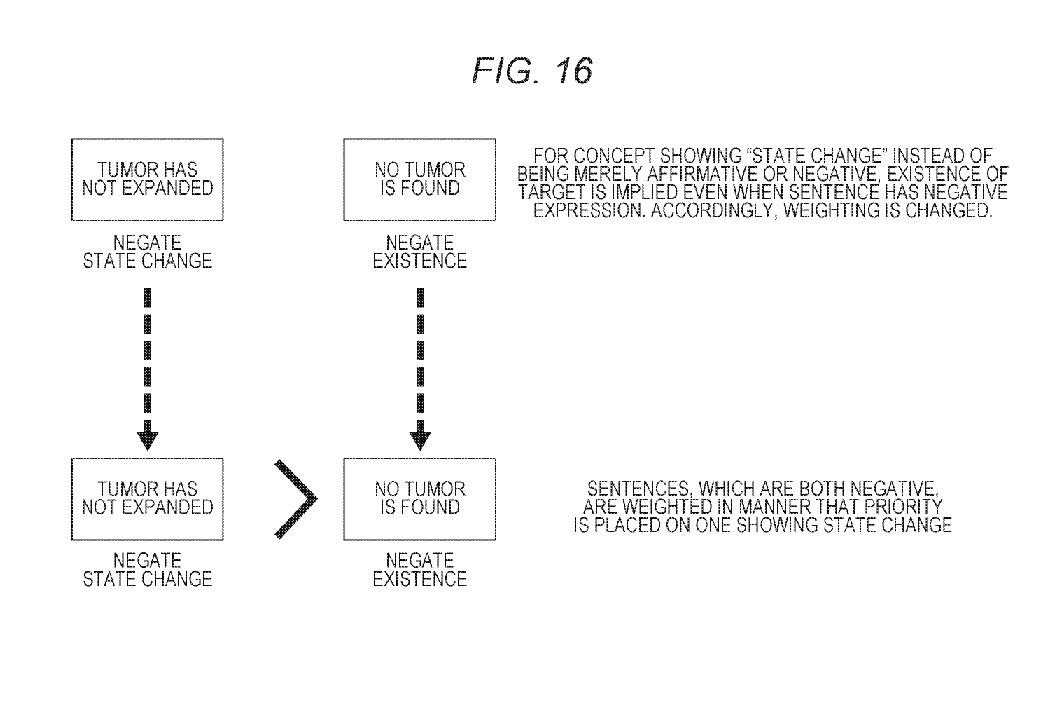

FIG. 17 is a diagram showing an example where weighting based on a continuing period of a matter is required.

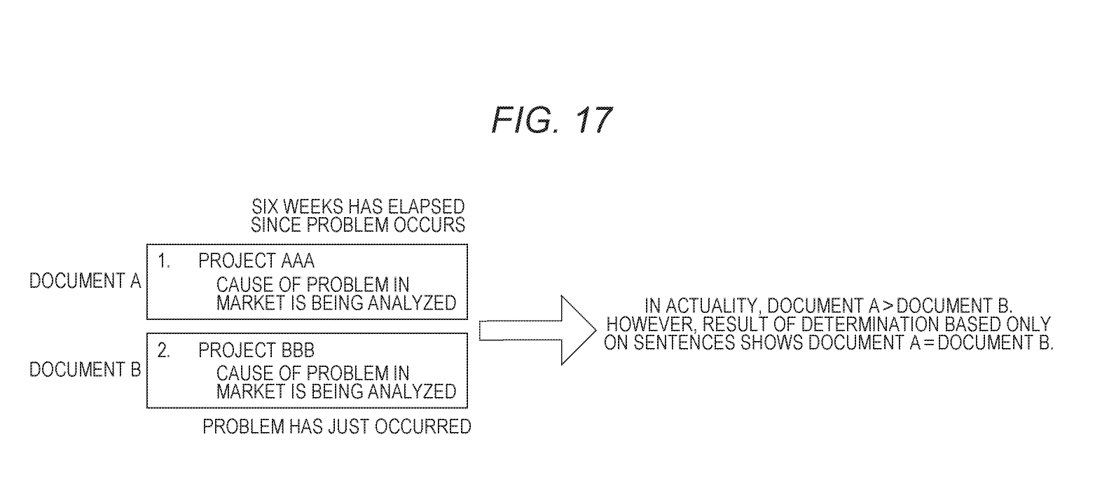

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

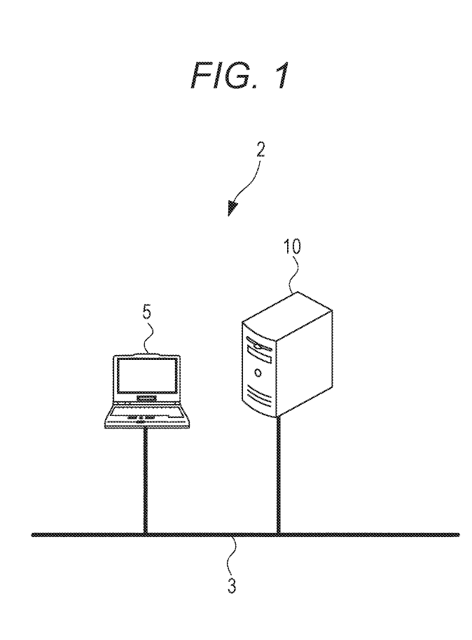

FIG. 1 is a diagram showing an example of a document composition analysis system 2 including a PC 5 according to an embodiment of the present invention. The document composition analysis system 2 includes a network 3, such as a local area network (LAN), to which a server 10 playing a role as a sentence scoring device according to the present invention and the PC 5 are connected.

The PC 5 is a terminal device, such as a personal computer, used by the user. The PC 5 includes a central processing unit (CPU), a read only memory (ROM), a random access memory (RAM), and the like, and operates based on an operating system (OS) and a variety of programs, such as an application program. In the embodiment of the present invention, the PC 5 creates and stores a document, and inputs a document into the server 10 and requests scoring of a sentence in the input document.

Upon input of a document from the PC 5 and receiving a request for scoring a sentence in the document, the server 10 extracts a sentence from the document and performs scoring. In the scoring according to the embodiment of the present invention, a matter shown by an extracted sentence is identified first, and after a continuing period of the matter is acquired, a first weighting value of the sentence is derived based on the acquired continuing period. Next, after a keyword included in a sentence is extracted, a second weighting value of the sentence is derived based on the extracted keyword. A final weighting value of a sentence is determined based on the first weighting value and the second weighting value. The method of identifying a matter, the method of calculating a continuing period of the matter, and the like will he described later.

As described above, when performing scoring for one sentence, the server 10 performs scoring in consideration of not only a content of the sentence but also a continuing period of a matter shown by the sentence. For example, when a content of a sentence relates to solving a problem, and a continuing period of a matter shown by the sentence (a target problem) is long, it is expected that the occurred problem has not been solved yet and is prolonged. Accordingly, the degree of importance is preferably set to be high in view of difficulty of solving the problem. In contrast, when the continuing period of the matter shown by the sentence is short, there is high possibility that the problem can be solved easily. Accordingly, the need for setting a high degree of importance is low. Accordingly, scoring can be performed more in accordance with such an actual situation as compared with a case where scoring is performed based only on a content of a sentence.

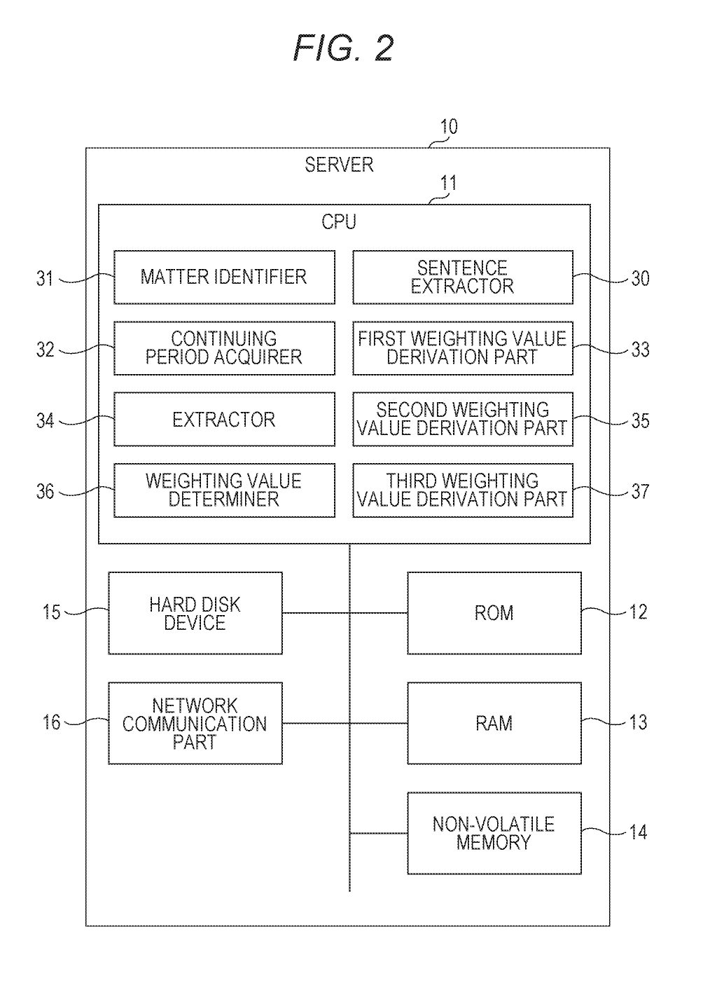

FIG. 2 is a block diagram showing a schematic configuration of the server 10. The server 10 includes a central processing unit (CPU) 11 that controls overall operation of the server 10. A read only memory (ROM) 12, a random access memory (RAM) 13, a non-volatile memory 14, a hard disk device 15, a network communication part 16, and the like are connected to the CPU 11 through a bus.

The CPU 11 executes middleware, an application program, and the like based on an OS program. The ROM 12 and the hard disk device 15 store a variety of programs, and the CPU 11 executes a variety of types of processing in accordance with the programs, so that functions of the server 10 are performed.

The RAM 13 is used, for example, as a work memory that temporarily stores a variety of types of data when the CPU 11 executes processing based on a program and an image memory that stores image data.

The non-volatile memory 14 is a memory (flash memory) whose stored content is not destroyed even when power is turned off; and is used fir storing a variety of types of setting information and the like. The hard disk device 15 is a large-capacity and non-volatile storage device, and stores image data, and the like as well as a variety of types of programs and data. In the embodiment of the present invention, the hard disk device 15 stores a document input by the PC 5, a history of a scored document, keywords and weighting values of keywords, and the like.

The network communication part 16 performs a function of communicating with the PC 5 and other external devices through the network 3.

In the embodiment of the present invention, the CPU 11 plays a role of a sentence extractor 30 that extracts a sentence from a document, a matter identifier 31 that identifies a matter shown by a sentence, a continuing period acquirer 32 that acquires a continuing period of a matter, a first weighting value derivation part 33 that derives a first weighting value of a sentence based on the acquired continuing period, an extractor 34 that extracts a keyword included in a sentence, a second weighting value derivation part 35 that derives a second weighting value of the sentence based on the extracted keyword, a weighting value determiner 36 that determines a weighting value of a sentence based on the first weighting value and the second weighting value, and a third weighting value derivation part 37 that derives a third weighting value corresponding to an identification item to which a sentence is connected.

In the embodiment of the present invention, the server 10 first extracts a sentence from a document, and then performs scoring of the sentence based on a content of the sentence. In this case, scoring is performed based on a keyword included in a sentence, a title related to the sentence, and the like. After that, a weighting value based on a continuing period of a matter shown by the sentence is used to calculate a final weighting value (final score) of the sentence. Processing performed until calculation of a final score will be described.

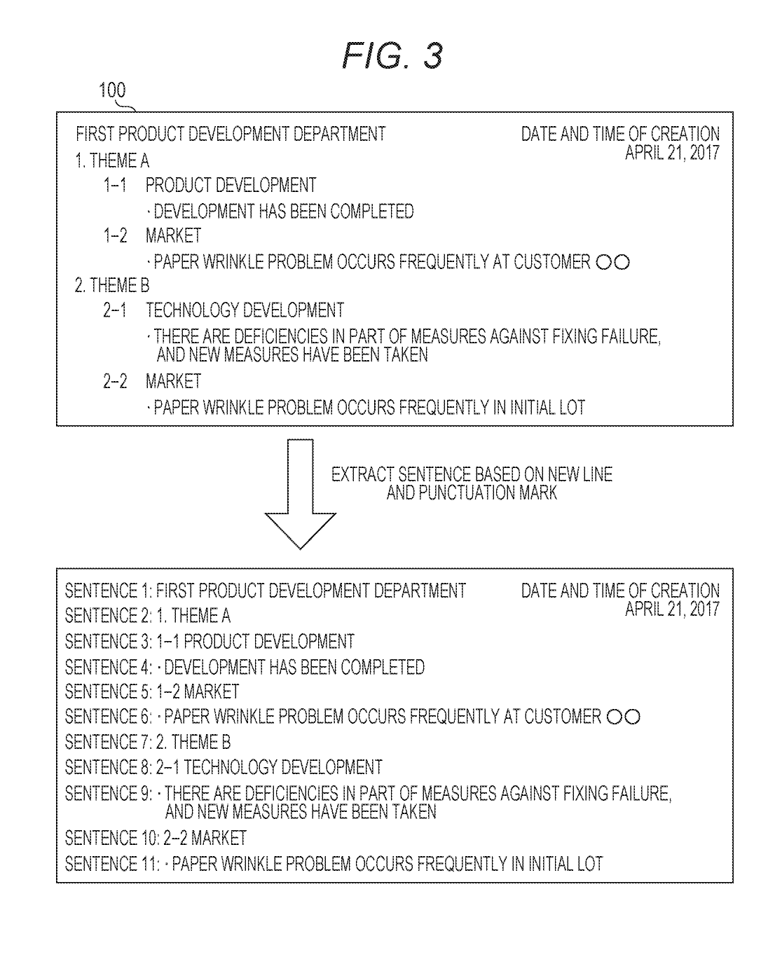

First, a method of extracting a sentence from a document will be described. FIG. 3 shows a state in which a sentence is extracted from a document. In FIG. 3, a new line and a punctuation mark are treated as expressions at the end of a sentence, and a sentence that is separated at such expressions is extracted as one sentence. A method of extracting a sentence from a document is not limited to the one described above.

A document 100 of FIG. 3 has a layer structure as follows:

First Product Development Department
Date and time of creation Apr. 21, 2017

```
1. Theme A
  1-1 Product Development
    Development has been completed
  1-2 Market
    Paper wrinkle problem occurs frequently at Customer ∘∘
2. Theme B
  2-1 Technology Development
    There are deficiencies in part of measures against fixing failure,
    and new measures have been taken.
  2-2 Market
    Paper wrinkle problem occurs frequently in initial lot.
```

When the document is divided at each punctuation mark and new line, the following sentences 1 to 11 can be extracted:

Sentence 1: First Product Development Department Date and time of
creation Apr. 21, 2017
Sentence 2: 1. Theme A
Sentence 3: 1-1 Product Development
Sentence 4: Development has been completed
Sentence 5: 1-2 Market
Sentence 6: Paper wrinkle problem occurs frequently at Customer ∘∘
Sentence 7: 2. Theme B
Sentence 8: 2-1 Technology Development
Sentence 9: There are deficiencies in part of measures against fixing
failure, and new measures have been taken.
Sentence 10: 2-2 Market
Sentence 11: Paper Wrinkle problem occurs frequently in initial lot.

The server 10 analyzes a structure of the document 100 when extracting a sentence from the document 100. A method of analyzing a document structure may be any method. The embodiment of the present invention analyzes which of a chapter, a section, a paragraph, main text, and the like each sentence corresponds to based on, for example, how an indent and a serial number are attached, and a layer structure of the sentences.

Next, the server 10 detects a keyword and a title to be extracted that are related to scoring of each sentence. In the embodiment of the present invention, a character string which is a keyword and a title to be extracted is registered in the server 10 in advance. When the registered character string is in a sentence, the character string is detected. A weighting value is set to each registered character string in advance, and the weighting value is used to calculate a weighting value of a sentence.

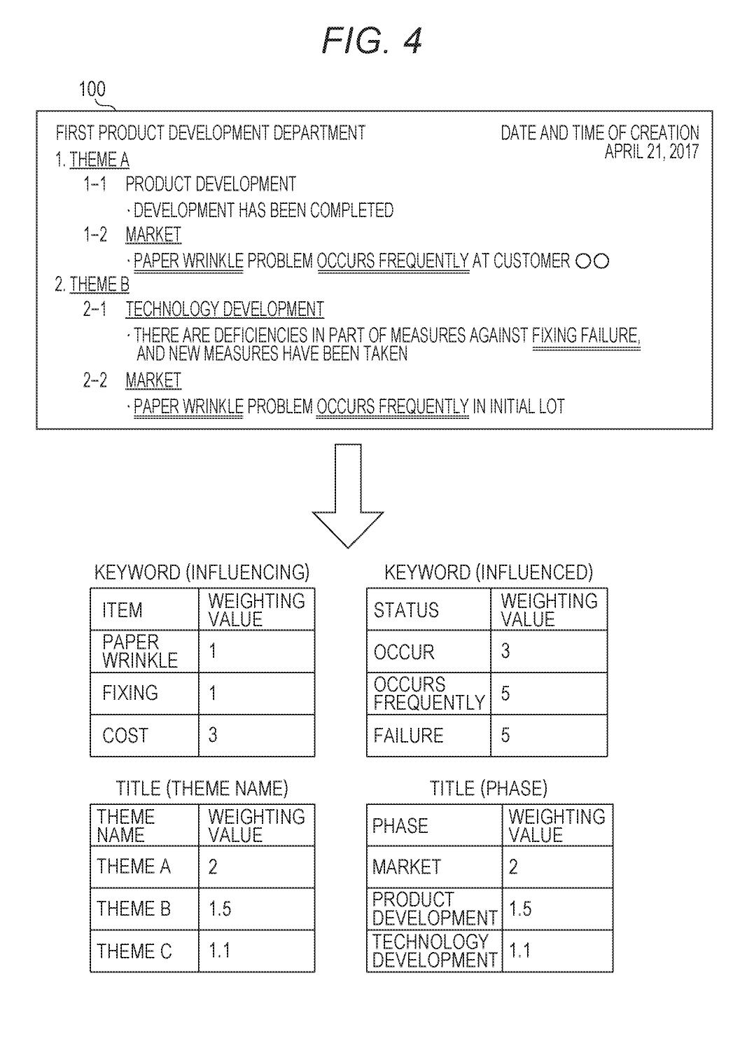

FIG. 4 shows a keyword and a title to be extracted in the document 100, and weighting values set to them. In the document 100 of FIG. 4, a keyword is doubly-underlined and a title is underlined.

In the embodiment of the present invention, a keyword may be in an influential relationship with other keywords. There is a keyword (keyword (influencing) in the diagram) that influences a succeeding keyword and a keyword (keyword (influenced) in the diagram) that is influenced by a preceding keyword.

FIG. 4 shows “paper wrinkle”, “fixing”, and “cost” as the keywords (influencing), and “occur”, “occurs frequently”, and “failure” as the keywords (influenced). FIG. 4 also shows theme names (Theme A, Theme B, and Theme C) and phases (market, product development, and technology development) as the titles.

In FIG. 4, weighting values set to character strings of keywords and titles to be extracted are as follows:

“paper wrinkle”→1

“fixing”→1

“cost”→3

“occur”→3

“occurs frequently”→5

“failure”→5

“Theme A”→2

“Theme B”→1.5

“Theme C”→1.1

“market”→2

“product development”→1.5

“technology development”→1.1

Next, a method of scoring a sentence based on a keyword and a title will be described. In the embodiment of the present invention, the server 10 performs scoring only for a sentence that includes both the keyword (influencing) and the keyword (influenced).

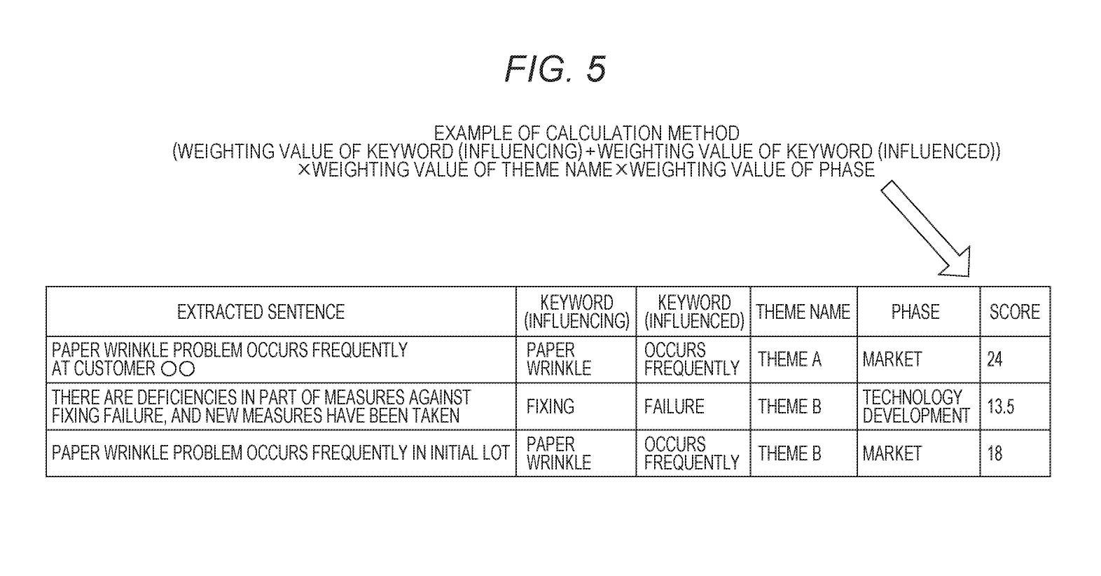

FIG. 5 shows an example where a sentence is scored based on a keyword and a title extracted in FIG. 4. In FIG. 5, scoring is performed for three sentences, Sentence 6, Sentence 9, and Sentence 11, in FIG. 3 that include two keywords in an influential relationship.

In the embodiment of the present invention, when scoring of a sentence is performed, a weighting value corresponding to a title of a layer, to which the sentence relate, or a higher layer, is used for scoring of the sentence. A calculation formula in this case is

“(weighting value of keyword (influencing)+weighting value of keyword (influenced)×weighting value of title (theme name)×weighting value of title (phase)”

however, the calculation formula used at the time of scoring is not limited to the above, and tray be other calculation formulas.

Sentence 6 includes the keyword (influencing) “paper wrinkle” and the keyword (influenced) “occurs frequently”, and titles of layers higher than or equal to a layer on which Sentence 6 is positioned are “Theme A” and “market”. When weighting values corresponding to these character strings are substituted into the above calculation formula, the score of “24” is obtained. By a similar method, the score of “13.5” is calculated from Sentence 9, and the score of “18” is calculated from Sentence 11.

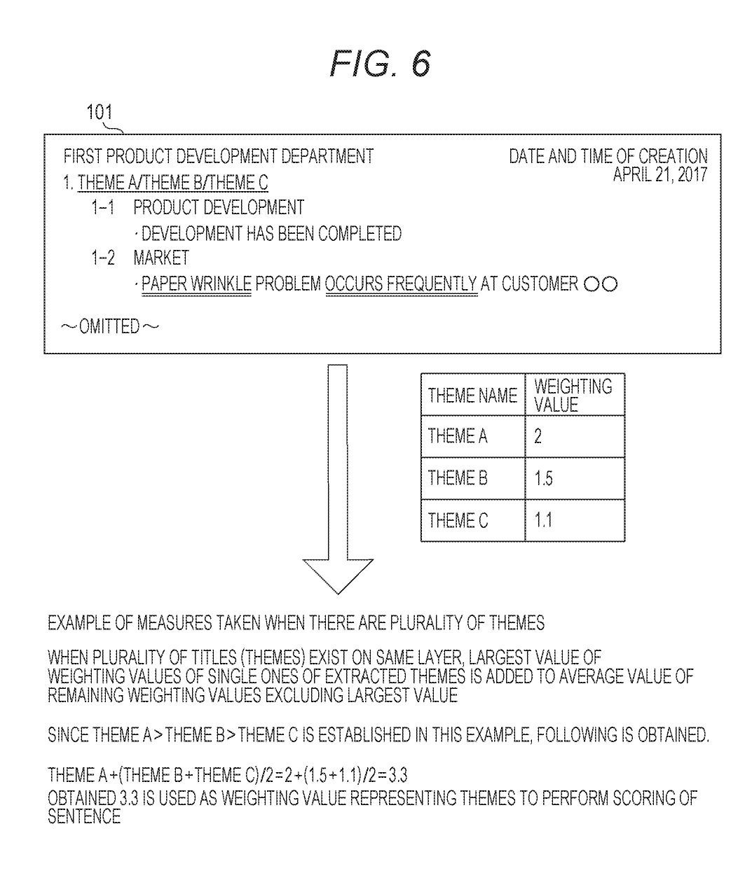

FIG. 6 shows an example of a method of measures taken when a plurality of titles are included on the same layer. In a document 101 of FIG. 6, three themes (Theme A, Theme B, and Theme C) are described in parallel as titles on the same layer, and sentences positioned on lower layers of the themes are determined to be related to all of the three themes described in parallel,

In this case, a value obtained by adding a largest value of weighting values of single ones of the extracted themes (Theme A, Theme B, and Theme C) to an average value of the remaining weighting values excluding the largest value is used as a weighting value representing titles of them of the themes. In this example, since Theme A>Theme B>Theme C, the following equation is obtained:

Theme A+(Theme B+Theme C)÷2=2+(1.5+1.1)÷2=3.3

The calculated value 3.3 is used as a weighting value representing the theme names to perform scoring of the sentence. The embodiment of the present invention handles the case in the above manner. However, the method of handling the case where a plurality of titles is included on the same layer is not limited to the above.

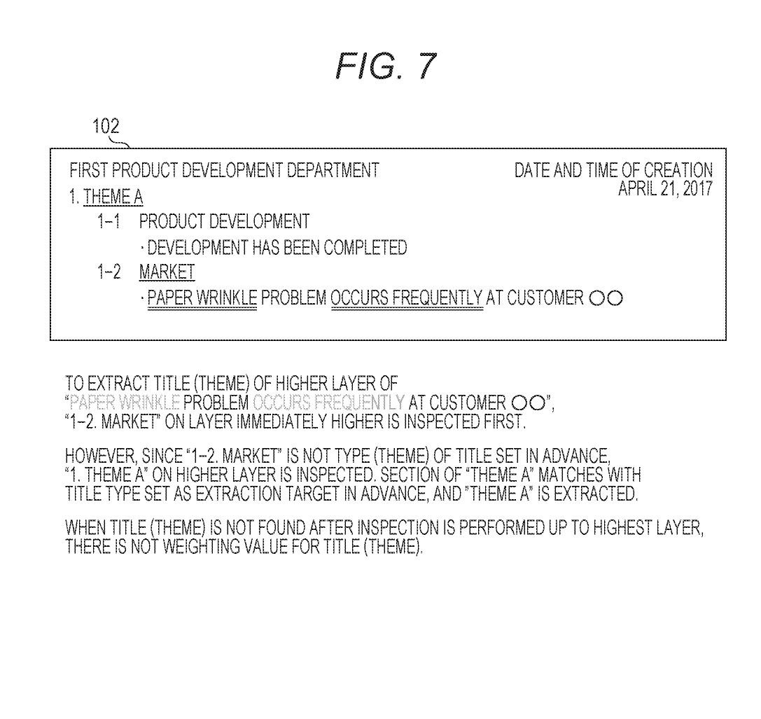

In FIG. 5, titles of two layers, a theme name and a phase, are used as titles of layers higher than or equal to a layer on which a sentence to be scored is positioned. In FIG. 7, a case where only a title of one layer is used at the time of scoring will be described.

FIG. 7 shows an example of an extraction method in a case where only a title of one layer among titles of layers higher than or equal to a layer on which a certain sentence is positioned is extracted. In the embodiment of the present invention, a type of a title to be extracted is determined in advance, and a title is extracted only when a title of the type exists.

In FIG. 7, a title of a layer higher than or equal to a layer on which the sentence “Paper wrinkle problem occurs frequently at Customer ∘∘” is positioned in the document 102. A type of a title to be extracted is a theme name. First, “1-2 Market” on the same layer as the sentence is inspected. However, “1-2” and “Market” are not appropriate for a content of a type (theme name) set in advance. Accordingly, a title of “1. Theme A” which is an upper layer of“1-2 Market” is inspected. The section of“Theme A” can be acknowledged as a title of the type determined as an extraction target in advance, and “Theme A” is extracted. When no title is extracted even after inspection is performed to a top layer, scoring of a sentence is performed by considering that a title of the specified type cannot be extracted.

As described above, a type of a title to be used for scoring may be determined in advance, or a title of a layer of a sentence to be scored, or a title on one layer higher than that of the sentence may he determined to be used.

When scoring based on a keyword and a title is completed for one sentence, a matter shown by the sentence is identified, and a continuing period of the matter is acquired. A weighting value corresponding to the acquired continuing period is used to calculate a final weighting value (final score) of the sentence. First, an identifying method of a matter will be described.

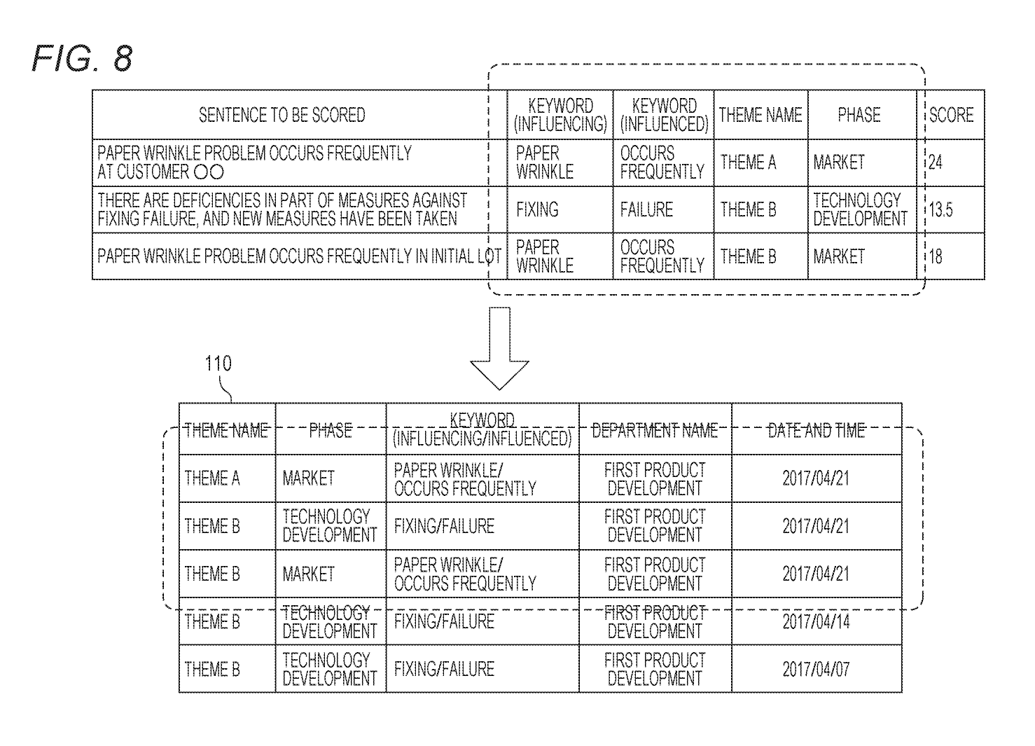

When performing scoring based on a keyword and a title, the server 10 registers a combination of a keyword and a title used for the scoring, a variety of types of information relating to the sentence as a scoring history in association with date and time of creation of the scored sentence. The scoring history plays a rote as a history of creation of a sentence in the present invention. A variety of types of information relating to a sentence is assumed to be a department name in this example. In the server 10, a matter shown by a sentence is identified based on a combination of the registered keyword, theme, phase, and department name. FIG. 8 shows a state of storing a matter shown by a sentence in a scoring history 110 based on a result of the scoring performed in FIG. 5.

A department name and date and time in the scoring history 110 are acquired from a header, a footer, a character string in a specific area in a document, property of a document, a file name, file information, and the like. A department name, and date and time may be acquired by other methods. For example, when a sentence is extracted from the document 100 of FIG. 3, a content of each extracted sentence is analyzed, and a department name and date and time of creation are acquired from Sentence 1.

Consider a case Where a continuing period is acquired for a matter shown by a certain sentence. First, when there is a record in a scoring history in which all “keyword”, “title (theme name, phase, or the like)”, and “department name” match with those in a sentence to be scored, the sentence indicated by the record and the sentence to be scored are determined as sentences relating to a common matter. Accordingly, a temporal difference between date and time of an oldest one of records relating to a matter that matches with that shown by a sentence to be scored and date and time of creation of the sentence to be scored is extracted, and the extracted temporal difference is used as a continuing period of a matter shown by the sentence to be scored.

In the embodiment of the present invention, a record is determined as that for a sentence showing a matter common to a sentence to be score only when a combination of all of “keyword”, “title (theme name, phase, or the like)”, and “department name” completely matches. However, the configuration may be such that a record is determines as that for a sentence showing a common matter when part of the combination matches (for example, “keyword” and “title” match),

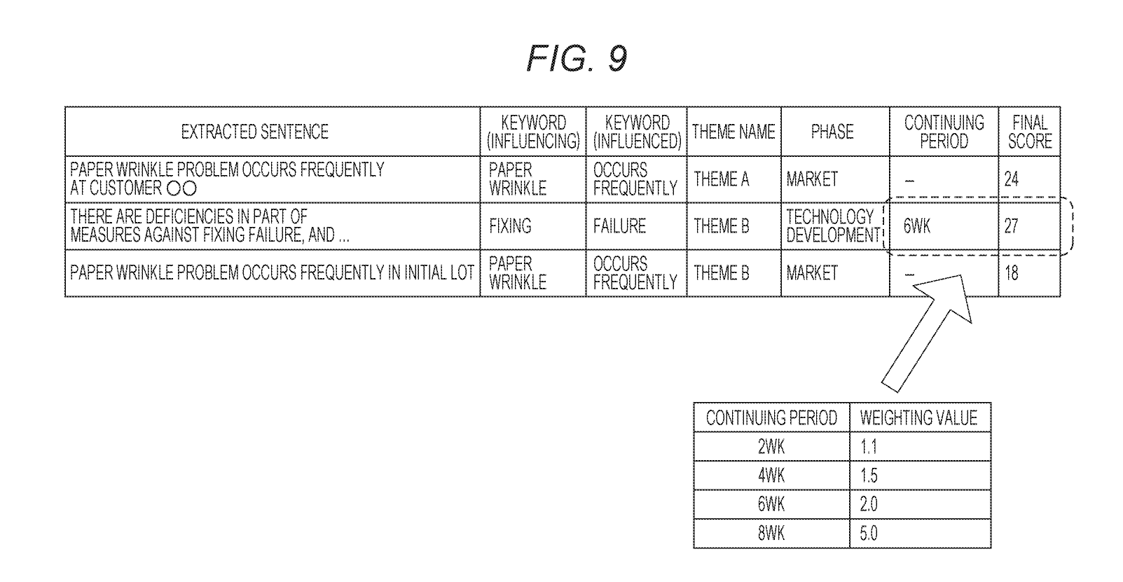

In the embodiment of the present invention, a weighting value corresponding to a continuing period is set in advance. FIG. 9 shows three sentences, matters shown by the sentences, a continuing period, and a final score in a table. FIG. 9 further shows a table of weighting values corresponding to continuing periods.

In FIG. 9, a continuing period of a matter (a matter identified by fixing, failure, Theme B, technology development, and first product development) shown by the sentence “There are deficiencies in part of measures against fixing failure, and . . . ” is six weeks (shown as 6 WK in the diagram) (2017/03/10 to 04/21, refer to FIG. 8). Matters shown by the other two sentences have no continuing period.

For a sentence relating to a matter having a continuing period, a weighting value corresponding to the continuing period is multiplied by a score calculated based on a keyword and a title, so that a final score is calculated. In FIG. 9, a weighting value corresponding to the continuing period of six weeks is 2.0. Accordingly, “27” obtained by multiplying the score (13.5, refer to FIGS. 5 and 8) calculated based on a keyword and a title by 2.0 is set as a final score. For a matter without a continuing period, a value obtained by multiplying a score calculated based on a keyword and a title by 1 is set as a final score.

Next, a case where a matter that has once been completed in the past occurs again will be described. First, the server 10 sets and stores in advance expressions for distinguishing between whether or not a matter shown by a sentence is completed, such as character strings of “completed”, “has been”, and “closed”. When an expression indicating completion is detected in a sentence during scoring of the sentence, and a matter shown by the sentence is registered in association with a fact that the matter has been completed.

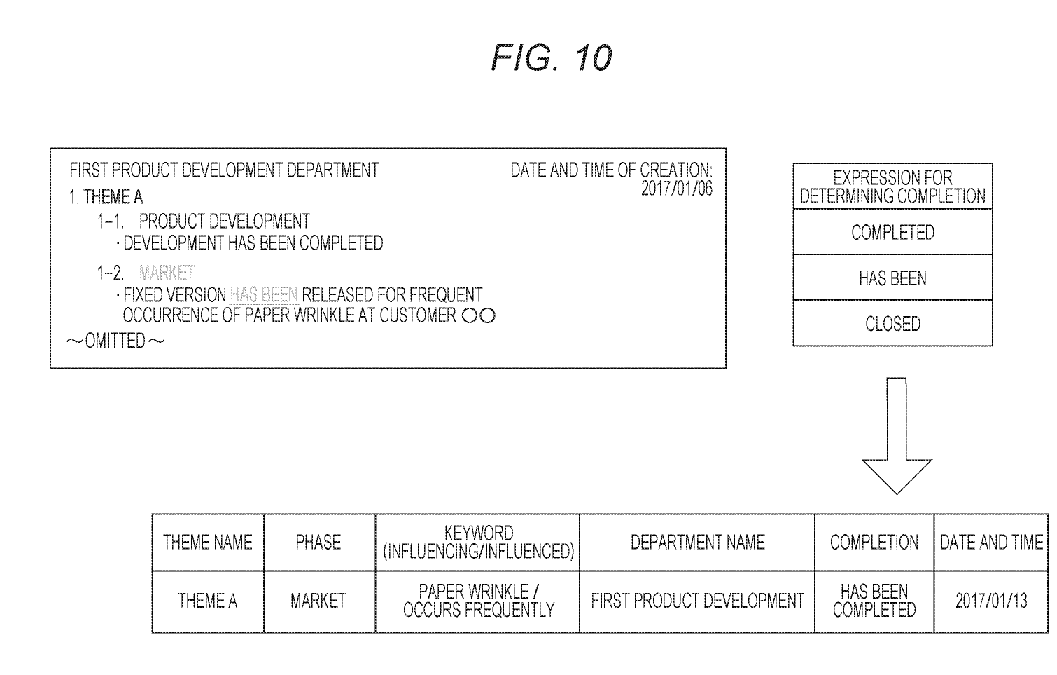

FIG. 10 shows an example where a fact that a matter has been completed is also registered in a scoring history. In this example, a character string of “has been” is found in a sentence “a fixed version has been released for frequent occurrence of paper wrinkle at customer ∘∘”. Accordingly, “has been completed” is also registered in addition to “keyword”, “title (theme name, phase, or the like)”, and “department name” in a scoring history.

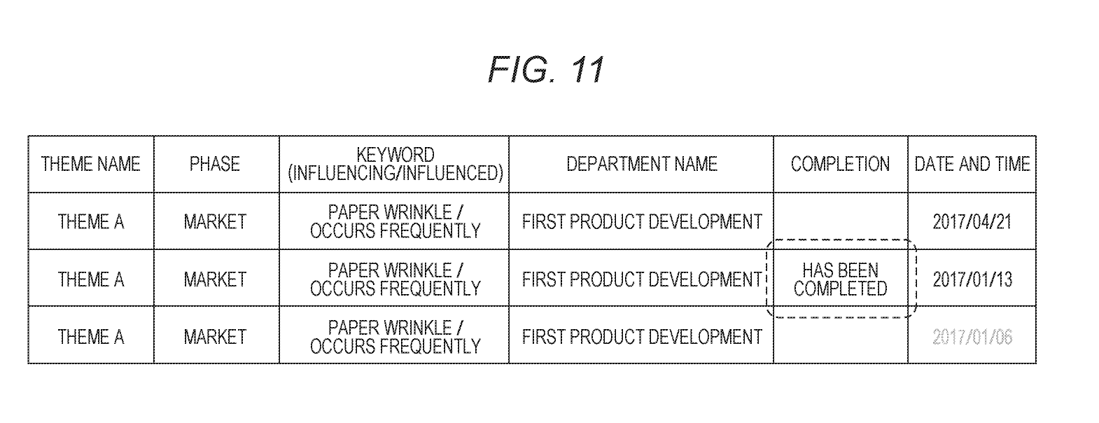

Next, a method of acquiring a continuing period of a matter in consideration of a record of “has been completed” described above will be described. FIG. 11 shows three records relating to a matter identified by “Theme A, market, paper wrinkle, occurs frequently, first product development” in a scoring history. Dates and times of the three records are “2017/01/06”, “2017/01/13”, and “2017/04/21”. In the record of “2017/01/13”, a fact that the matter has been completed is recorded.

In FIGS. 8 and 9, a continuing period is calculated from a temporal difference between date and time of an oldest one of records for the same matter in a scoring history and date and time of creation of a sentence to be scored. When there is a record that has been completed, a continuing period is calculated based only on a record of date and time after the completion.

In FIG. 11, the matter has been completed in the record of “2017/01/13”. Accordingly, prior records (“2017/01/13” and “2017/01/06”) are excluded, and a continuing period is calculated from a temporal difference between the oldest record “2017/04/21” among records after the record of “2017/01/13” and the present. For example, when scoring is newly performed for a sentence showing the same matter as the record of FIG. 11, and date and time of the sentence is “2017/05/21”, a continuing period is determined to be four weeks. If there is no record alter the record showing a matter has been completed, the matter is determined not to have occurred, and a continuing period is set to “0”.

Next, a case where scoring is performed in consideration of the number of times of recurrence of a matter will be described. A record of a sentence that shows a matter common to that shown by a sentence and shows that the matter has been completed is registered in a scoring history, the number of records showing that the matter has been completed is assumed to be the number of times of recurrence of the matter, and a coefficient corresponding to the number of times of recurrence is multiplied at the time of calculation of a final score.

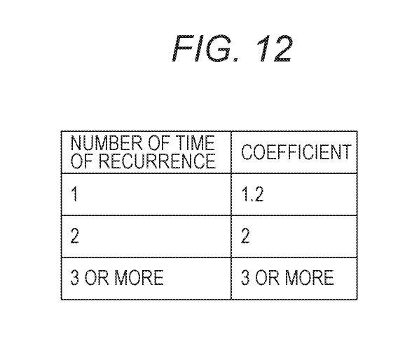

When the number of records showing the matter has been completed is one, the number of times of recurrence is one. When the number of records showing the matter has been completed is two, the number of times of recurrence is two. FIG. 12 shows the number of times of recurrence and a coefficient corresponding to the number of times of recurrence. When the number of times of recurrence is one, the coefficient is set to 1.2, when the number of times of recurrence is two, the coefficient is set to 2, and when the number of times of recurrence is three or larger, the same number as the number of times of recurrence is set to the coefficient.

For example, when the sentence relating to the record of “2017/04/21” of FIG. 11 is created, the same matter has already been completed once. Accordingly, the number of times of recurrence is set to 1, and a final score is a value obtained by multiplying a numerical value calculated by the method described in FIG. 9 by a coefficient of 1.2.

The server 10 performs scoring for a sentence and calculates a final score in the manner described above. Since scoring is performed in consideration of not only a keyword in a sentence, but also a title of a layer higher than or equal to a layer on which the sentence is positioned, a continuing period of a matter shown by the sentence, the number of times of recurrence, and the like, scoring that more reflects an actual situation can be performed as compared with a case where scoring is performed only based on a keyword in a sentence.

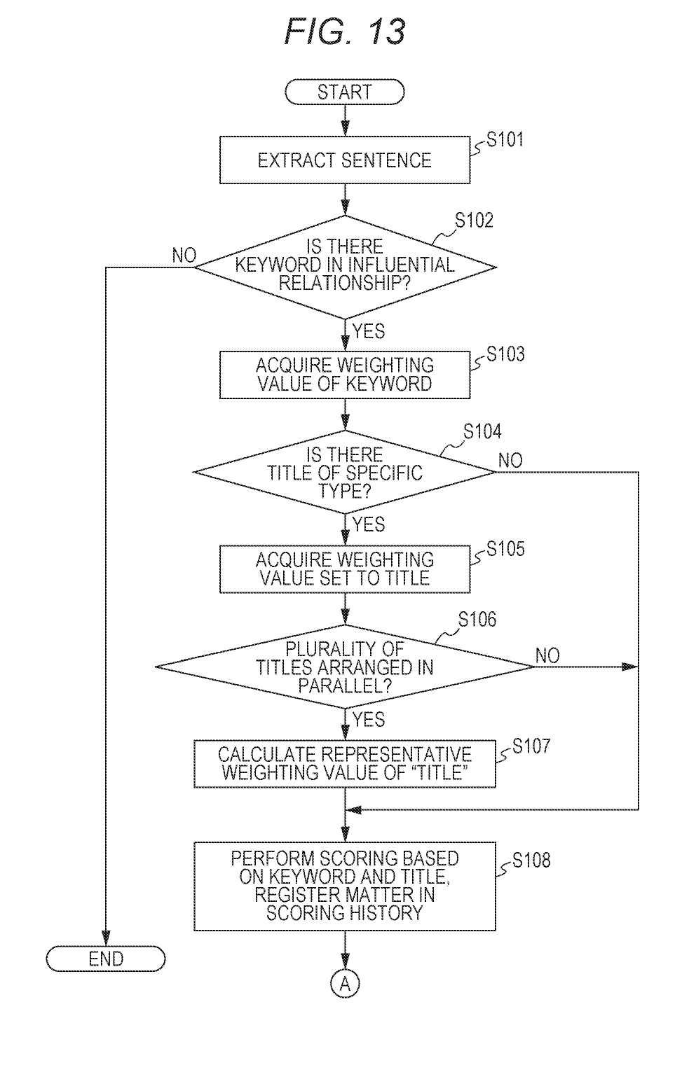

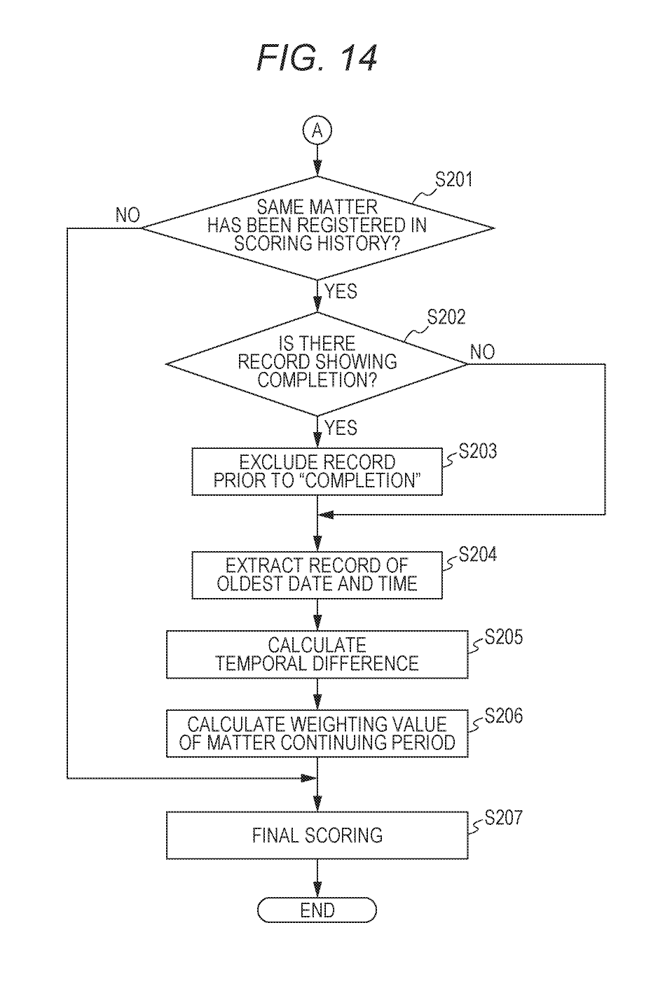

Next, a process of processing performed by the server 10 according to the embodiment of the present invention will be described. FIGS. 13 and 14 are flowcharts showing a process of processing executed by the server 10 performing scoring of a sentence. FIG. 13 shows a process of processing of scoring based on a keyword and a title, and FIG. 14 shows a process of processing of calculating a final score by calculating a continuing period of a matter.

First, in Step S101 of FIG. 13, a sentence is extracted from a document by the method described in FIG. 3. When two keywords in an influential relationship are not in the extracted sentence (Step S102; No), the present processing is finished. When there are two keywords in an influential relationship in the extracted sentence (Step S102; Yes), weighting values of the keywords are acquired (Step S103).

Next, whether or not there is a title of a type determined in advance, such as “theme name”, in a title of a layer higher than or equal to a layer on which a sentence is positioned is checked (Step S104). When there is not a title of a type determined in advance (Step S104; NO), the processing proceeds to Step S108. When there is a title of a type determined in advance (Step S104; Yes), a weighting value set to the title in advance is acquired (Step S105).

When a single title is detected in Step S104 (Step S106; No), the processing proceeds to Step S108. When a plurality of titles arranged in parallel are detected in Step S104 (Step S106; Yes), a weighting value representing the titles is calculated by the method described in FIG. 6 (Step S107).

In Step S108, scoring based on a keyword and a title is performed by the calculation method described in FIG. 5, a combination of the keyword, the title, and the like is set as a matter shown by a sentence, and a record that associates the matter with date and time of creation of the sentence is created and registered in a scoring history,

When a matter shown by a sentence is registered in a scoring history, the matter may be registered in association with other pieces of information, such as a department name, as an element that identifies the matter as described in FIG. 8. After a scoring history is registered, the processing proceeds to Step S201 of FIG. 14.

In Step S201 of FIG. 14, a record of a matter in common with the matter registered in Step S108 is extracted from a scoring history (Step S201). If there is no record of a matter in common with the matter registered in Step S108 (Step S201; No), the processing proceeds to Step S207.

When records of a common matter are extracted (Step S201; Yes), whether or not there is a record showing that the matter has been completed among the records is checked (Step S202).

When there is a record showing that the matter has been completed (Step S202; Yes), a record prior to the record showing that the matter has been completed is excluded (Step S203), and the processing proceeds to Step S204. When there is not a record showing that the matter has been completed (Step S202; No), the processing proceeds to Step S204.

in Step S204, a record of oldest date and time is extracted from extracted records. When a record prior to the record showing that the matter has been completed is excluded in Step S203, a record of oldest date and time is extracted from the remaining records. After that, a temporal difference between date and time of the extracted record and the present is extracted (Step S205), and a weighting value of a continuing period of a matter shown by a sentence to be scored is acquired from the calculation result (Step S206).

After the above, a final score is calculated by the method described in FIG. 9 based on the score calculated in Step S108 of FIG. 13 and a weighting value of a continuing period acquired in Step S206 (Step S207), and the present processing is finished.

In Step S104 of the flowchart of FIG. 13, a character string relating to a fact that a matter has been completed is searched for in addition to a title. When a character string relating to a fact that a matter that has been completed is detected, the fact that the matter shown by a sentence has been completed is also registered when the matter is registered in a scoring history in Step S108.

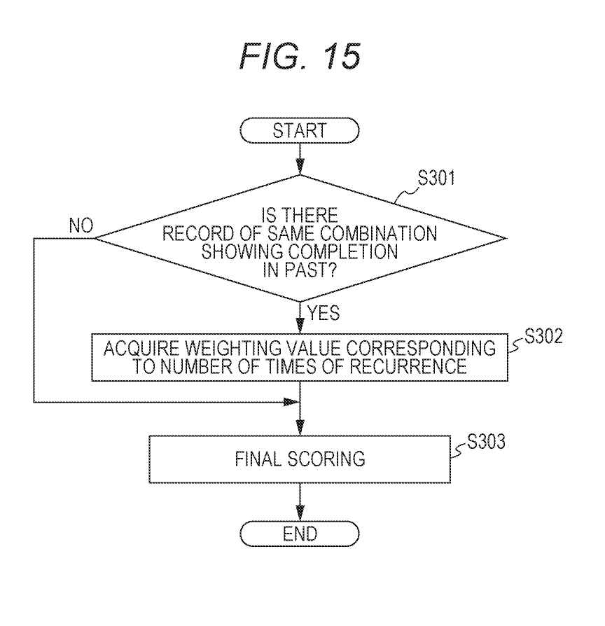

FIG. 15 shows a flowchart when the number of times of recurrence is taken into consideration. First, whether or not a record showing that a matter that has been completed is included in records extracted from a scoring history in Step S201 is checked (Step S301). When there is not a record showing that a matter has been completed (Step S301; No), the processing proceeds to Step S303.

When there is a record showing that a matter has been completed (Step S301; Yes), a weighting value (coefficient) corresponding to the number of records showing that a matter has been completed (the number of times of recurrence) is acquired (Step S302), the final score calculated in Step S207 is multiplied by the weighting value to calculate a final score again (Step S303), and the present processing is finished.

The processing of FIGS. 13 to 15 is repeatedly performed for each sentence detected from a document.

The embodiment of the present invention has been described above with reference to the drawings. However, a specific configuration is not limited to the embodiment, and a change or an addition within a range not deviating from the gist of the present invention is also included in the present invention.

In the embodiment of the present invention, the server 10 plays a role as a sentence scoring device of the present invention. However, the sentence scoring device is not limited to the above. For example, other devices, such as the PC 5 and an MFP, may play a role as the sentence scoring device.

A method of extracting a sentence from a document and a method of extracting a keyword, a title, and the like are not limited to those described in the embodiment of the present invention. A keyword, a title, and the like are not limited to those described in the present invention. A calculation formula used for scoring is not limited to the one described in the embodiment. In the embodiment of the present invention, weighting values (coefficients) of a keyword, a title, a continuing period, the number of times of recurrence, and the like are set in advance. However, the weighting values may be changeable by the user.

The method of acquiring a continuing period is not limited to the method described in the embodiment of the present invention. For example, the continuing period may be acquired by a method, such as inquiring another server and the like in which a situation of a matter shown by a sentence is recorded. The method of identifying a matter is not limited to the method described in the embodiment of the invention. A matter may be identified by using or combining keywords other than a keyword relating to scoring, or a matter may be identified by a combination of elements of part of a keyword and a theme used for scoring.

In the embodiment of the present invention, scoring of a sentence is performed by using a weighting value of a title of a layer higher than or equal to a layer on Which the sentence is positioned. However, scoring of the sentence may be performed only based on a keyword and a continuing period of a matter shown, by the sentence.

In the embodiment of the present invention, types of a title of a layer higher than or equal to a layer on which a sentence is positioned are “theme name”, “phase”, and the like. However, the types of a title may be “product name”, “project name”, “negotiation name”, “department name”, “information of person in charge”, “date of creation”, and the like. The type of a title only needs to include any one of them.

A creation history of a sentence different from a scoring history may also be used to acquire a continuing period of a matter shown by a sentence. This creation history is preferably a database with which a document created in the past, a creation date of a sentence, and a matter may be identified.

In the embodiment of the present invention, a weighting value is larger as a continuing period is longer. Alternatively, a weighting value may be larger as a continuing period is shorter. The configuration may also be such that, while a continuing period is shorter than a predetermined period, a weighting value is made larger as the continuing period becomes longer, and when the continuing period exceeds a predetermined period, a weighting value is made smaller as the continuing period becomes longer (that is, a weighting value is lowered when a continuing period is constantly long). A relationship between a continuing period and a weighting value may also be such that a weighting value is rapidly changed as the continuing period exceeds a certain period, and may be set optionally.

Although embodiments of the present invention have been described and illustrated in detail, the disclosed embodiments are made for purposes of illustration and example only and not limitation. The scope of the present invention should be interpreted by terms of the appended claims.

What is claimed is:

1. A sentence scoring device comprising
a hardware processor that:
extracts a sentence from a document;
identifies a matter shown by the sentence;
acquires a continuing period of the identified matter;
derives a first weighting value of the sentence based on the acquired continuing period;
extracts a keyword included in the sentence;
derives a second weighting value of the sentence based on the extracted keyword; and
determines a weighting value of the sentence based on the first weighting value and the second weighting value.

2. The sentence scoring device according to claim 1, wherein
the keyword is a certain character string to which a weighting value is set in advance.

3. The sentence scoring device according to claim 1, wherein
the keyword is a character string showing a risk.

4. The sentence scoring device according to claim 1, wherein
the hardware processor acquires a continuing period of the matter shown by the sentence based on a creation history of another sentence showing a matter that is the same as the matter shown by the sentence.

5. The sentence scoring device according to claim 1, wherein
the hardware processor determines whether or not the matter identified by the hardware processor is a matter that has been completed in the past, and
when the hardware processor determines that the matter shown by the sentence is a matter that has been completed in the past, the hardware processor acquires a continuing period from recurrence of the matter after the completion as a continuing period of the matter.

6. The sentence scoring device according to claim 1, wherein the document has a layer structure, and
the hardware processor derives a third weighting value corresponding to a title of a layer higher than or equal to a layer to which a sentence extracted by the hardware processor relates, and sets a weighting value of the sentence based on the first weighting value, the second weighting value, and the third weighting value.

7. The sentence scoring device according to claim 6, wherein
the title includes at least any one of “product name”, “project name”, “theme name”, “phase”, “negotiation name”, “department name”, “information of person in charge”, and “date of creation”.

8. The sentence scoring device according to claim 6, wherein
when there is a plurality of titles on the same layer, the hardware processor derives the third weighting value based on a weighting value set to each of the titles in advance.

9. A non-transitory recording medium storing a computer readable program causing an information processor to operate as the sentence scoring device according to claim 1.
